(19) United States
(12) Patent Application Publication
(10) Pub. No.: US 2015/0103934 A1
(43) Pub. Date: Apr. 16, 2015

(54) METHOD AND APPARATUS FOR COMMUNICATION IN MILLIMETER WAVE MIMO COMMUNICATION ENVIRONMENT

(71) Applicant: Electronics and Telecommunications Research Institute, Daejeon (KR)

(72) Inventors: Junyoung Nam, Daejeon (KR); Juho Park, Suwon-si Gyeonggi-do (KR); Jae Young Ahn, Daejeon (KR)

(21) Appl. No.: 14/514,569

(22) Filed: Oct. 15, 2014

(30) Foreign Application Priority Data
Oct. 16, 2013 (KR) 10-2013-0123565
Dec. 6, 2013 (KR) 10-2013-0151677
Oct. 13, 2014 (KR) 10-2014-0137947

(51) Int. Cl. H04L 27/26

(52) U.S. Cl. CPC H04L 27/2608; H04L 27/2626; H04L 27/2647
USPC 375/260

(57) ABSTRACT

A method and apparatus for communication in millimeter wave multiple input multiple output (MIMO) communication are provided. A beamforming matrix by groups for terminals that are classified into a group is generated, and a pilot signal that is beam-formed based on the generated beamforming matrix by groups is transmitted to the terminals. Channel information based on the pilot signal is received from the terminals, hybrid beamforming scheduling is performed based on the channel information, and data is transmitted to the terminals based on the scheduling.

### CROSS-REFERENCE TO RELATED APPLICATION

This application claims priority to and the benefit of Korean Patent Application No. 10-2013-0123565, No. 10-2013-0151677, and No. 10-2014-0137947 filed in the Korean Intellectual Property Office on Oct. 16, 2013, Dec. 6, 2013, and Oct. 13, 2014, the entire contents of which are incorporated herein by reference.

### BACKGROUND OF THE INVENTION

(a) Field of the Invention

The present invention relates to method and apparatus for communication in a millimeter wave multiple input multiple output (MIMO) communication environment.

(b) Description of the Related Art

Frequency efficiency needs to be increased by 1000 times compared to the existing efficiency in a mobile communication system because of an rapid increase of data traffic. To increase the frequency efficiency, there a scheme providing a service with an ultra wideband (UWB) in millimeter waves.

There are some problems to be solved in the UWB wireless communication, and typically, the number of radio frequency (RF) chains and the complexity of an analog to digital converter (ADC) and a digital to analog converter (DAC) have to be decreased to feasible levels. For this, a scheme of combining digital beamforming and analog beamforming has been proposed, and is referred to as hybrid beam forming.

The hybrid beamforming is very effective in single user MIMO, but has a disadvantage in that the complexity of precoding, receiving an algorithm, and scheduling increases exponentially when the total sum of data streams in multiple user MIMO increases, thereby it is impossible to design a practical system.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide method and apparatus for multiple users in a millimeter wave multiple input multiple output (MIMO) communication environment.

An exemplary embodiment of the present invention provides a method for communication in millimeter wave multiple input multiple output (MIMO) communication. The method includes: generating a beamforming matrix by groups for terminals that are classified into a group; transmitting a pilot signal that is beam-formed based on the generated beamforming matrix by groups to the terminals; receiving channel information based on the pilot signal from the terminals and performing hybrid beamforming scheduling based on the channel information; and transmitting data to the terminals based on the scheduling, wherein in the transmitting of a pilot signal, a pilot signal of a first period and a pilot signal of a second period are transmitted through an additional resource.

The first period may be longer that the second period.

The pilot signal may be a channel state information-grouping reference signal (CSI-GRS).

In the performing of scheduling, the channel information may include at least one of multi-user interference (MUI) of an interference signal of which intensity is greater than a predetermined threshold value among interference signals of a terminal, and a precoding matrix indicator (PMI) of the MUI.

The performing of hybrid beamforming scheduling may perform hybrid beamforming that calculates a digital beamforming matrix by groups based on the PMI of the MUI of the interference signal and a precoding matrix selected by a terminal, wherein the digital beamforming matrix may be a block diagonal matrix.

Also, the method may further include: before the generating of a beamforming matrix by groups, obtaining, by a base station, statistical channel information from the terminal; and classifying the terminals into a class and a group of the class based on the statistical channel information.

The obtaining of statistical channel information may include transmitting a channel status index-reference signal (CSI-RS) to the terminals, and obtaining the statistical channel information that is reported from the terminals based on the results of measuring the CSI-RS.

Another embodiment of the present invention provides an apparatus for communication in millimeter wave multiple input multiple output (MIMO) communication. The apparatus includes: a hybrid beamforming processor that generates a beamforming matrix by groups for terminals that are classified into a group and transmits a pilot signal that is beam-formed based on the generated beamforming matrix by groups to the terminals; a scheduling processor that receives channel information based on the pilot signal from the terminals and performs hybrid beamforming scheduling based on the channel information; and a data transmission processor that transmits data to the terminals based on the scheduling, wherein the hybrid beamforming processor transmits a pilot signal of a first period and a pilot signal of a second period through an additional resource.

The first period may be longer that the second period, and the pilot signal may be a channel state information-grouping reference signal (CSI-GRS).

The channel information may include at least one of multi-user interference (MUI) of an interference signal of which the intensity is greater than a predetermined threshold value among interference signals of a terminal, and a precoding matrix indicator (PMI) of the MUI.

The hybrid beamforming processor may perform hybrid beamforming that calculates a digital beamforming matrix by groups based on the PMI of the MUI of the interference signal and a precoding matrix selected by a terminal, wherein the digital beamforming matrix is a block diagonal matrix.

In addition, the apparatus may further include: a statistical channel information obtaining processor that obtains statistical channel information from the terminal; and a terminal classifying processor that classifies the terminals into a class and a group of the class based on the statistical channel information.

### BRIEF DESCRIPTION OF THE DRAWINGS

FIG. 1 shows hybrid beamforming according to an exemplary embodiment of the present invention.

FIG. 2 shows a flowchart of a communication method according to an exemplary embodiment of the present invention.

FIG. 3 shows a configuration diagram of a communication apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification, in addition, unless explicitly described to the contrary, the word “comprise” and variations such as “comprises” or “comprising” will be understood to imply the inclusion of stated elements but not the exclusion of any other elements.

In this specification, a terminal may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., and may include the entire or partial functions of the MT, the MS, the AMS, the HR-MS, the SS, the PSS, the AT, the UE, etc.

A base station (BS) may designate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (HR-RS) serving as a base station, a high reliability relay station (HR-RS) serving as a base station, a small base station (femto BS, a home node B (HNB), a home eNodeB (HeNB), a pico BS, a metro BS, a micro BS, etc.), etc., and may include all or some functions of the ABS, the nodeB, the eNodeB, the AP, the RAS, the BTS, the MMR-BS, the RS, the RN, the ARS, the HR-RS, the small base station, etc.

Hereinafter, a method and apparatus for communication multiple input multiple output (MIMO) communication environment according to an exemplary embodiment of the present invention will be described.

In a communication environment in which communication is performed through a uplink and a downlink of a cellular communication, it is assumed that there are a base station with M antennas and K terminals with N_{RX} antennas in a cell and that transmitting antenna correlation of each terminal is high (i.e., an angle spread (AS) is low). For example, in a millimeter wave channel environment, in downlink of an urban macro environment, and in a channel environment in which line of sight (LOS) is high, transmitting antenna correlation appears to be high. In addition, for better comprehension and ease of description, it is assumed that K terminals may be divided into G groups that may be spatially separated based on similarity of transmitting antenna correlation, and that each group includes K′=K/G terminals.

In such a communication environment, when beamforming based on hybrid beamforming combining digital beamforming and analog beamforming is performed, a transmitting signal formed by the hybrid beamforming may be represented as follows.

x=BPd [Equation 1]

Here, B represents an analog beamforming matrix of M×N_{RF} dimension, P represents a digital beamforming matrix of N_{RF}×N_{S} dimension (or a digital precoding matrix), and d represents a data symbol vector. Also, N_{RF} represents the number of radio frequency (RF) chains and N_{S} represents the total sum of data streams. N_{RF}≦N_{RF} is a necessary condition between N_{RF} and N_{S}.

Meanwhile, a received signal may be represented as follows.

y=HBPd+z [Equation 2]

Here, H represents a system channel matrix of KN_{RX}×M dimensions, z represents background noise and interference signals of other cells, and B represents an analog beamforming matrix of M×N_{RF} dimensions.

Multi-user MIMO communication is highly desirable in that system efficiency increases linearly as the number of users increases. However, as the total sum of data streams N_{S} increases, the calculation complexity of the digital precoding matrix P increases exponentially as well as the complexity of scheduling, and thereby it is very difficult to perform the multi-user MIMO communication.

In an exemplary embodiment of the present invention, joint spatial division multiplexing (JSDM) is used. The JSDM is a scheme that approximates a product HB in which a system channel matrix is multiplied by an analog beamforming matrix to produce a block diagonal matrix by using the similar orthogonality between transmission correlation matrices of terminals. The product HB approximated to the block diagonal matrix may be represented as follows.

$$HB = [ \begin{matrix}{H}_{1} {B}_{1} & {H}_{1} {B}_{2} & … & {H}_{1} {B}_{G} \\ {H}_{2} {B}_{1} & {H}_{2} {B}_{2} & … & {H}_{2} {B}_{G} \\ ⋮ & ⋮ & ⋱ & ⋮ \\ {H}_{G} {B}_{1} & {H}_{G} {B}_{2} & … & {H}_{G} {B}_{G}\end{matrix} ] \approx [ \begin{matrix}{H}_{1} {B}_{1} & 0 & … & 0 \\ 0 & {H}_{2} {B}_{2} & … & 0 \\ ⋮ & ⋮ & ⋱ & ⋮ \\ 0 & 0 & … & {H}_{G} {B}_{G}\end{matrix} ] \qquad [ Equation 3 ]$$

Here, H_{g} represents the entire channel matrix of a group g and B_{g} represents an analog beamforming matrix of a group g.

If the product HB of an effective channel is approximated to the block diagonal matrix, a digital beamforming matrix P may also be approximated to the block diagonal matrix as follows.

P=diag(P₁, . . . ,P_{G}) [Equation 4]

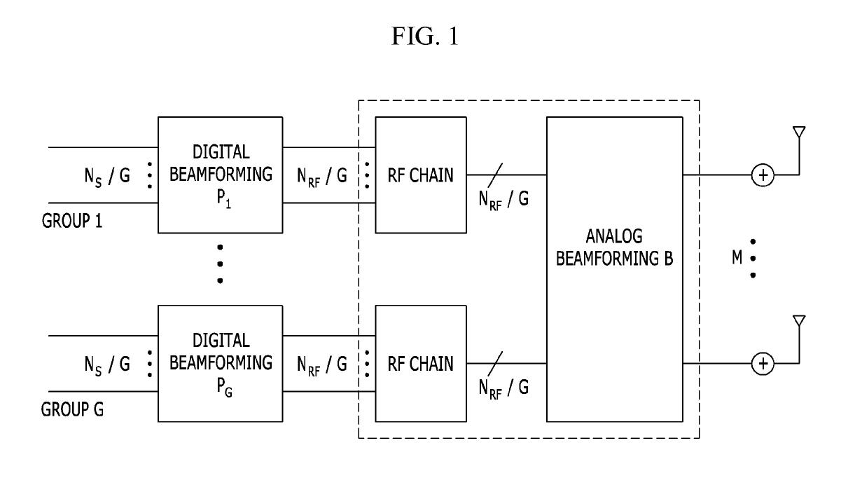

This beamforming may be represented as in FIG. 1.

FIG. 1 shows hybrid beamforming according to an exemplary embodiment of the present invention.

As shown in FIG. 1, digital beamforming matrices P₁, . . . , P_{G} of G groups that are spatially separated according to the similarity of transmitting antenna correlations are approximated to a block diagonal matrix. Instead of calculating digital beamforming matrices of N_{RF}×N_{S} dimensions, sub-block beamforming matrices of

$$\frac{{N}_{RF}}{G} \times \frac{{N}_{S}}{G}$$

dimensions are calculated so that the complexity of calculating the digital beamforming matrix can be greatly reduced.

Beamforming matrices B_{g} and P are set to satisfy with the above conditions, and terminals having them are simultaneously scheduled. It is possible to perform scheduling by groups according to an exemplary embodiment of the present invention. Therefore, scheduling by groups of a subset is performed instead of performing scheduling for all users, which causes the scheduling complexity to be greatly reduced. Accordingly, as well as the system transmission efficiency increase through the multi-user MIMO communication in a millimeter wave band, the complexity in calculating digital beamforming matrices and the complexity of scheduling can be reduced to at least a feasible level.

In MIMO communication according to an exemplary embodiment of the present invention, a base station obtains statistical channel information on at least one terminal and classifies the terminal to at least one class and at least one group depending on the class based on the statistical channel information. The base station determines a group beamforming matrix for each group and performs group beamforming transmission based on the group beamforming matrix. After that, the base station obtains instantaneous channel information, performs scheduling to terminals, and transmits data to the terminals based on the scheduling.

The base station transmits a pilot signal, for example, a channel status index-reference signal (CSI-RS), to terminals and the terminals feed back the results of measuring the received CSI-RS to the base station. The base station can obtain the statistical channel information based on the feedback. At this time, the terminal may feed back the results including information on the interference caused by other terminals to enhance the performance of the multi-user MIMO.

The terminal uses a multi-user interference (MUI) feedback scheme of feeding back the intensity of the interference caused by a pre-coding matrix that belongs to a subset of a code book capable of being multi-user paired with the terminal. Accordingly, the base station may estimate a multi-user-channel quality indicator (MU-CQI) to be applied to a multi-user MIMO link and obtain interference information between terminals so that a demodulation-reference signal (DM-RS) port can be shared with terminals between which there is very low interference.

The size of a code book increases as the number of antennas in a large scale antenna system increases. Therefore, the number of precoding matrices considered in multi-user scheduling to each terminal increases, such that the feedback overhead of terminals greatly increases.

In a propagation environment of a millimeter wave band according to an exemplary embodiment of the present invention, the interference between terminals occurs restrictedly since there are very few multipaths. The following feedback scheme using these may be used.

A terminal feeds back a precoding matrix of its choice and an MUI of an interference signal that is greater than a predetermined threshold value among interference signals that belong to a subset of a code book capable of being multi-user paired with the terminal. That is, the terminal extracts an interference signal of which the intensity is greater than a predetermined threshold value from among interference signals caused by other terminals having a precoding matrix that belongs to a subset of a code book capable of being multi-user paired with the terminal. Then, the terminal feeds back the MUI of the extracted interference signal.

Also, the precoding matrix indicator (PMI) of the MUI may be reported back. At this time, information in a bitmap format corresponding to the number of interference precoding matrix candidates may be reported or each PMI of each MUI may be reported, respectively. Through the reporting, resource demand for the feedback of the MUI may be greatly reduced.

Meanwhile, when transmitting a pilot signal (or a reference signal) with a large-scale transmitting antenna system in a millimeter wave channel environment, the pilot signal has to be beam-formed in consideration of path attenuation. At this time, because a large number of very narrow beams (grid of beams) is transmitted, there a problem in that a terminal has to search and track an optimal beam among them within a very short time.

Taking this into consideration, a base station transmits a pilot signal as follows in an exemplary embodiment of the present invention.

According to multi-user MIMO communication, a base station transmits a pilot signal, for example, a channel status index-group specific reference signal (CSI-GRS). The CSI-GRS is a reference signals (RS) specialized in a particular group of G groups that may be spatially separated based on similarity of transmitting antenna correlation. Also, the CSI-RS is an RS by which a beamforming matrix specialized by groups is multiplied.

The CSI-GRS includes a pilot signal beam-formed with a long period and a pilot signal beam-formed with a short period. The pilot signal beam-formed with a long period, that is, a long period pilot signal, represents a beam of which the range of the angle based on the statistical channel information of terminals is large and wide. The pilot signal beam-formed with a short period, that is, a short period pilot signal, represents a beam of which the range of the angle based on the statistical channel information of terminals is small and narrow.

In an exemplary embodiment of the present invention, the long period pilot signal and the short period pilot signal are transmitted through an additional resource. A base station transmits the long period pilot signal and the short period pilot signal through the additional pilot resource (which may be referred to as a CSI-GRS port), wherein the pilot signals are transmitted through the same resource shared between groups.

By transmitting the long period pilot signal and the short period pilot signal through the additional pilot resource, the long period pilot signal may be transmitted with a long period and the short period pilot signal may be transmitted with a short period. Accordingly, it is possible to minimize the resource demand quantity. In addition, the long period pilot signal is designed to be wide so that it overlaps with the range of other pilot signals. In this case, use in a cell may be perceived as if there is no pilot shadow area. Also, unlike a pilot signal having a very narrow angle and a short period for beamforming, the long period pilot signal may be constructed with a small number of pilot signals even though a large scale antenna system is used. Therefore, it is possible to transmit pilot signals with fewer pilot resources, such that the beam searching time of a terminal may be reduced.

Meanwhile, a terminal may select its class and its group through the long period pilot signal and measure a channel for CSI feedback through the short period signal to generate various CSIs. The terminal may track an optimal beam by using the long period pilot signal and the short period pilot signal.

Based on the description above, a method for multi-user MIMO communication according to an exemplary embodiment of the present invention will now be described.

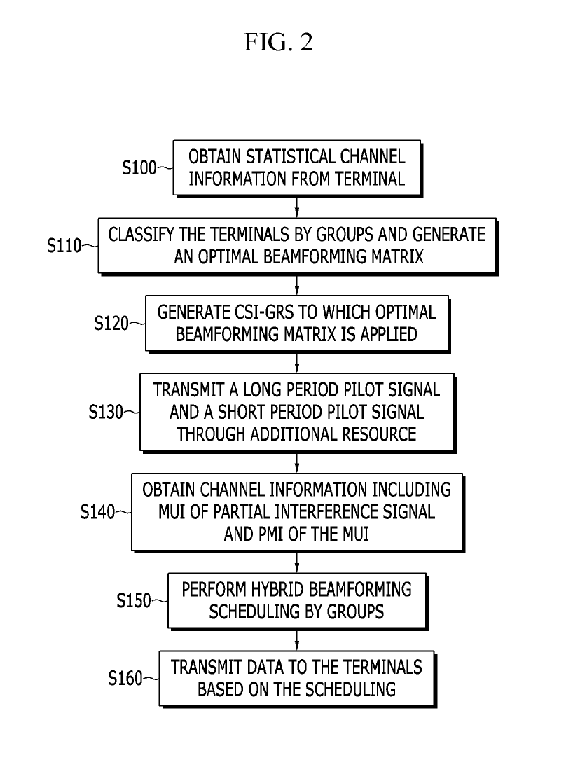

FIG. 2 shows a flowchart of a method for multi-user MIMO communication according to an exemplary embodiment of the present invention.

In a millimeter wave (mmWave) communication environment, a base station obtains statistical channel information on at least one terminal (S100). For example, the base station measures a sounding reference signal (SRS) transmitted from terminals to obtain statistical channel information or transmits a long period CSI-RS to terminals so that statistical channel information measured by the terminals is reported back. Here, the statistical channel information includes, for example, a unique vector matrix of a terminal, an angle spread (AS) of a terminal, or an angle of departure (AoD). The statistical channel information may include at least one long period precoding matrix indicator (PMI) selected from a fixed code book.

The base station classifies terminals into a class and its dependent group by using the statistical channel information, and determines an optimal beamforming matrix by groups. The base station performs group classification, for example, by binding terminals with which effective unique vectors are similar into a group, and performs class classification, for example, by binding groups in which the orthogonality between unique vectors vector is high into a class. The classes may use different resources and groups of a class may use the same resource. The base station generates an optimal beamforming matrix by groups, and particularly, generates an analog beamforming matrix B_{g} that is approximated to a block diagonal matrix (S110).

Then, the base station may generate a channel vector by terminals of each group and perform precoding to the terminals of each group with an algorithm based on the channel vector.

Meanwhile, the base station broadcasts a pilot signal (i.e., a CSI-GRS) beam-formed with the beamforming matrix generated by groups. The CSI-GRS includes a long period pilot signal and a short period pilot signal, and is broadcasted through an additional resource. At this time, by transmitting the CSI-GRS through the same resource between groups, it is possible to reduce the resource demand quantity (S120 and S130).

A terminal measures channel information by using the CSI-GRS to which the beamforming matrix by groups is applied and reports them to the base station. Here, the terminal may report the channel information with a MUI scheme. Specifically, the terminal measures an interference signal caused within the same group and an interference signals caused by other group, and extracts interference signals of which the intensity is greater than a predetermined threshold value from among interference signals caused by other terminals having a precoding matrix that belongs to a subset of a code book capable of being multi-user paired with the terminal. Then, the terminal feeds back the MUIs of the extracted interference signals (they will be referred to as partial interference signals henceforth). At this time, the terminal may report their precoding matrix or the PMIs of the MUIs of the extracted interference signals along with the MUIs (S140). Meanwhile, the terminal may select its class and its group based on the long period CSI-GRS, and measure a channel based on the short period CSI-GRS to generate channel information. The terminal may perform the tracking of an optimal beam with the long period pilot signal and the short period pilot signal.

The base station performs scheduling to terminals based on the feedback channel information and transmits data to the terminals based on the scheduling. The base station performs scheduling by groups, and specifically, performs hybrid beamforming scheduling based on the precoding matrix selected by a terminal and the MUIs of interference signals included in the feedback channel information or the PMIs of the MUIs. The base station determines a MIMO mode and the construction thereof, for example, beam combination, MIMO streams, a PMI of a digital precoder, PMI, a modulation and coding scheme (MCS) level, and others by performing a hybrid beamforming scheduling based on statistical channel information for analog beamforming and channel information including PMIs for digital beamforming. After that, the base station allocates and transmits a data burst according to the results of the scheduling to the terminals (S160).

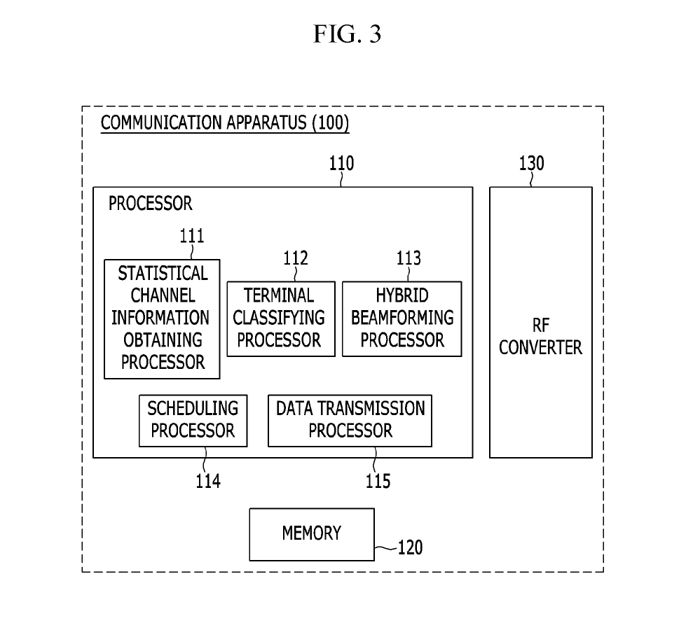

FIG. 3 shows a configuration diagram of a communication apparatus according to an exemplary embodiment of the present invention.

As shown in FIG. 3, a communication apparatus 100 of a base station includes a processor 110, a memory 120, and a radio frequency (RF) converter 130.

The processor 110 is constructed to perform the process and method described above based on FIG. 1 and FIG. 2. The processor 110 includes a statistical channel information obtaining processor 111, a terminal classifying processor 112, a hybrid beamforming processor 113, a scheduling processor 114, and a data transmission processor 115.

The statistical channel information obtaining processor 111 obtains statistical channel information on a terminal in a millimeter wave communication environment.

The terminal classifying processor 112 classifies terminals into a class and a group depending on the class based on the statistical channel information.

The hybrid beamforming processor 113 generates an optimal beamforming matrix by groups. For example, an analog beamforming matrix approximated to a block diagonal matrix is generated by groups. Also, a pilot signal beam-formed with the beamforming matrix generated by groups, that is, a CSI-RS, is generated and broadcasted. Here, the hybrid beamforming processor 113 broadcasts a CSI-GRS including a lone period pilot signal and a short period pilot signal through an additional resource.

Also, the hybrid beamforming processor 113 performs hybrid beamforming based on the channel information that is specialized by the CSI-GRS and reports feedback from a terminal. Digital beamforming matrices by groups are calculated based on the precoding matrix selected by the terminal and the PMI of the MUI of partial interference signals included in the feedback channel information. At this time, as shown in FIG. 1, the digital beamforming matrix is also approximated to a block diagonal matrix. Accordingly, the sub-block beamforming matrices of

$$\frac{{N}_{RF}}{G} \times \frac{{N}_{S}}{G}$$

dimensions are calculated, such that the complexity in calculating digital beamforming matrices can be reduced.

The scheduling processor 114 performs scheduling based on channel information feedback from the terminal and specialized in the CSI-GRS. The channel information includes the MUIs of the interference signals of which the intensity is greater than a predetermined threshold value among interference signals, which are caused by other terminals having a precoding matrix that belongs to a subset of a code book capable of being multi-user paired with the terminal, and the PMIs of the MUIs.

The scheduling processor 114 determines a MIMO mode and the construction thereof by performing scheduling for hybrid beamforming based on the channel information. The results of the scheduling for hybrid beamforming are provided to the hybrid beamforming processor 113.

The data transmission processor 115 allocates and transmits a data burst to the terminal based on the results of the scheduling.

The memory 120 is connected to the processor 110 and stores information related to the operation of the processor 110.

The RF converter 130 is connected to the processor 110 and receives or transmits a radio signal. The RF converter 130 may transmit and receive signals through multiple antennas.

According to an exemplary embodiment of the present invention, MIMO communication can be performed in a millimeter wave communication environment. Particularly, scheduling of terminals by groups is individually performed, and thereby the system complexity can be greatly reduced.

Also, by approximating a digital beamforming matrix by groups to a block diagonal matrix, it is possible to reduce the complexity in calculating the digital beamforming matrices since the calculation of the sub-block beamforming matrix is performed.

In addition, when a terminal feeds back channel information, the MUIs of the interference signals having greater intensity than a predetermined threshold value are reported, and thereby the resource demand quantity for feedback can be greatly reduced.

Further, by transmitting pilot signals for channel information feedback with additional resources, a long period pilot signal can be transmitted with a long period and a short period pilot signal can be transmitted with a short period.

Accordingly, it is possible to minimize the resource demand quantity.

The exemplary embodiments of the present invention may be implemented through the above-described apparatus and/or method, and may also be implemented with a program for realizing the functions corresponding to the elements of the exemplary embodiments of the present invention, and a recording medium storing the program. These implementations may be easily achieved from the description of the exemplary embodiments by a person of ordinary skill in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for communication in millimeter wave multiple input multiple output (MIMO) communication, comprising:
generating a beamforming matrix by groups for terminals that are classified into a group;
transmitting a pilot signal that is beam-formed based on the generated beamforming matrix by groups to the terminals;
receiving channel information based on the pilot signal from the terminals and performing hybrid beamforming scheduling based on the channel information; and
transmitting data to the terminals based on the scheduling,
wherein in the transmitting of a pilot signal, a pilot signal of a first period and a pilot signal of a second period are transmitted through an additional resource.

2. The method of claim 1, wherein the first period is longer that the second period.

3. The method of claim 2, wherein the pilot signal is a channel state information-grouping reference signal (CSI-GRS).

4. The method of claim 1, wherein in the performing of scheduling, the channel information includes at least one of multi-user interference (MUI) of an interference signal of which intensity is greater than a predetermined threshold value among interference signals of a terminal, and a precoding matrix indicator (PMI) of the MUI.

5. The method of claim 4, wherein the performing of hybrid beamforming scheduling performs hybrid beamforming that calculates a digital beamforming matrix by groups based on the PMI of the MUI of the interference signal and a precoding matrix selected by a terminal, wherein the digital beamforming matrix is a block diagonal matrix.

6. The method of claim 1, further comprising:
before the generating of a beamforming matrix by groups,
obtaining, by a base station, statistical channel information from the terminal; and
classifying the terminals into a class and a group of the class based on the statistical channel information.

7. The method of claim 6, wherein the obtaining of statistical channel information includes transmitting a channel status index-reference signal (CSI-RS) to the terminals, and obtaining the statistical channel information that is reported from the terminals based on the results of measuring the CSI-RS.

8. An apparatus for communication in millimeter wave multiple input multiple output (MIMO) communication, comprising:
a hybrid beamforming processor that generates a beamforming matrix by groups for terminals that are classified into a group and transmits a pilot signal that is beam-formed based on the generated beamforming matrix by groups to the terminals;
a scheduling processor that receives channel information based on the pilot signal from the terminals and performs hybrid beamforming scheduling based on the channel information; and
a data transmission processor that transmits data to the terminals based on the scheduling,
wherein the hybrid beamforming processor transmits a pilot signal of a first period and a pilot signal of a second period through an additional resource.

9. The apparatus of claim 8, wherein the first period is longer that the second period, and the pilot signal is a channel state information-grouping reference signal (CSI-GRS).

10. The apparatus of claim 8, wherein the channel information includes at least one of multi-user interference (MUI) of an interference signal of which the intensity is greater than a predetermined threshold value among interference signals of a terminal, and a precoding matrix indicator (PMI) of the MUI.

11. The apparatus of claim 8, wherein the hybrid beamforming processor performs hybrid beamforming that calculates a digital beamforming matrix by groups based on the PMI of the MUI of the interference signal and a precoding matrix selected by a terminal, wherein the digital beamforming matrix is a block diagonal matrix.

12. The apparatus of claim 8, further comprising:
a statistical channel information obtaining processor that obtains statistical channel information from the terminal; and
a terminal classifying processor that classifies the terminals into a class and a group of the class based on the statistical channel information.
